(19) United States
(12) Patent Application Publication
(10) Pub. No.: US 2019/0168938 A1
(43) Pub. Date: Jun. 6, 2019

(54) WATER-SOLUBLE PACKAGING WITH A BITTERING AGENT

(71) Applicant: Henkel AG & Co. KGaA, Duesseldorf (DE)

(72) Inventors: Frank Meier, Duesseldorf (DE); Martina Hermann, Duesseldorf (DE); Olaf Holtkoetter, Huerth (DE); Matthias Sunder, Duesseldorf (DE); Brigitte Giesen, Duesseldorf (DE)

(73) Assignee: Henkel AG & Co. KGaA, Duesseldorf (DE)

(21) Appl. No.: 16/265,820

(22) Filed: Feb. 1, 2019

Related U.S. Application Data
(62) Division of application No. 14/621,429, filed on Feb. 13, 2015, now abandoned.
Application No. 14/621,429 is a continuation of application No. PCT/EP2013/066199, filed on Aug. 1, 2013.

(30) Foreign Application Priority Data
Aug. 16, 2012 (DE) 10 2012 214 607.5

(51) Int. Cl. B65D 65/46; C11D 17/04; B65B 9/04

(52) U.S. Cl. CPC B65D 65/46; C11D 17/045; B65D 2215/00; B65B 9/04; C11D 17/042

(57) ABSTRACT

The patent application describes a method for manufacturing water-soluble packaging which contains an agent and a water-soluble wrapping. The water-soluble wrapping contains, at least in part, a bittering agent having a bitterness value between 1,000 and 200,000.

### FIELD OF THE INVENTION

The present invention generally relates to water-soluble packaging containing an agent and a water-soluble wrapping. The invention further relates to a method for manufacturing water-soluble packaging.

### BACKGROUND OF THE INVENTION

Detergents or cleaning agents are presently available to the consumer in various forms. In addition to powders and granules, these offered forms also include liquids, gels, or single-dose packages (tablets or filled pouches), for example.

In particular single-dose packages in the form of water-soluble packaging containing liquid detergents or cleaning agents are becoming increasingly popular; on the one hand they meet the consumer's demand for simplified dosing, and on the other hand, consumers increasingly prefer liquid detergents or cleaning agents.

Such a water-soluble pouch contains an agent and a transparent, water-soluble wrapping.

A packaged cleaning agent for washing dishes is known from WO 96/08555 A1, and is coated with the bittering agent Bitrex® (denatonium benzoate) to prevent children from accidentally ingesting the packaged cleaning agent.

Denatonium benzoate is considered to be the bitterest substance known, and has a bitterness value greater than 100,000,000.

One disadvantage of coating water-soluble packaging with Bitrex® is that the users of the water-soluble packaging pick up the package for dosing, and thus also come into contact with the Bitrex®. If a user moves the hand toward the mouth after contacting the water-soluble packaging, even small quantities of Bitrex® remaining on the hand are sufficient to adversely affect the sense of taste for a few hours.

The object of the invention, therefore, is to provide water-soluble packaging having a high level of child-resistance, but without negative effects during normal use.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Water-soluble packaging which contains an agent and a water-soluble wrapping, in which the water-soluble wrapping contains, at least in part, a bittering agent having a bitterness value between 1,000 and 200,000.

Method for manufacturing water-soluble packaging which includes an agent and a water-soluble wrapping which contains, at least in part, a bittering agent having a bitterness value between 1,000 and 200,000, including the following steps: forming at least one cavity in a first water-soluble film web; filling the at least one cavity with a product; and closing the cavity with a second water-soluble film web; characterized in that the bittering agent having a bitterness value between 1,000 and 200,000 is contained in the first and/or second water-soluble film web.

Method for manufacturing water-soluble packaging which includes an agent and a water-soluble wrapping which contains, at least in part, a bittering agent having a bitterness value between 1,000 and 200,000, including the following steps: forming at least one cavity in a first water-soluble film web; filling the at least one cavity with a product; and closing the cavity with a second water-soluble film web; and at least partially coating the outer surface of the water-soluble wrapping with a medium which contains the bittering agent having a bitterness value between 1,000 and 200,000.

Method for manufacturing water-soluble packaging which includes an agent and a water-soluble wrapping which contains, at least in part, a bittering agent having a bitterness value between 1,000 and 200,000, including the following steps: providing a first water-soluble film web; coating the first water-soluble film web with a medium which contains the bittering agent having a bitterness value between 1,000 and 200,000; forming at least one cavity in the first water-soluble film web; filling the at least one cavity with a product; and closing the cavity with a second water-soluble film web.

Method for manufacturing water-soluble packaging which includes an agent and a water-soluble wrapping which contains, at least in part, a bittering agent having a bitterness value between 1,000 and 200,000, including the following steps: forming at least one cavity in the first water-soluble film web; filling the at least one cavity with a product; providing a second water-soluble film web; coating the second water-soluble film web with a medium which contains the bittering agent having a bitterness value between 1,000 and 200,000; and closing the cavity with the second water-soluble film web.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The object of the invention is achieved by water-soluble packaging which contains an agent and a water-soluble wrapping, in which the water-soluble wrapping contains, at least in part, a bittering agent having a bitterness value between 1,000 and 200,000.

It has surprisingly been shown that bittering agents having these bitterness values have a sufficiently intense bitter taste to prevent children from continuing to retain a water-soluble package containing this bittering agent in or on the mouth, but during routine use of the water-soluble packaging are not so bitter that a residue of a bittering agent remaining on the hand intensely and unpleasantly irritates the taste buds of the user over an extended period of time in the event of accidental contact of the hand with the mouth.

### Water-Soluble Packaging

The subject matter of the invention relates to water-soluble packaging containing an agent and a water-soluble wrapping. The water-soluble wrapping contains, at least in part, a bittering agent having a bitterness value between 1,000 and 200,000.

The water-soluble packaging contains a water-soluble wrapping which forms a closed structure having one or more chambers in its interior for accommodating one more agents. The water-soluble wrapping is preferably formed by a water-soluble film material.

The water-soluble packaging may have a dimensionally stable or a deformable design.

The water-soluble packaging may be designed as a dimensionally stable receptacle, for example in the form of a capsule, box, can, or container.

In principle, however, it is also possible and preferred to form the water-soluble packaging as a nondimensionally stable container, for example as a pouch. The shape of this type of water-soluble packaging may be adapted to a great extent to the use conditions. Various shapes such as tubes, cushions, cylinders, bottles, or disks are suitable.

The water-soluble packaging may have one or more chambers for storing one or more agents. The water-soluble packaging preferably has between two and five chambers.

### Water-Soluble Wrapping

The water-soluble wrapping is preferably formed from a water-soluble film material which is selected from the group comprising polymers or polymer mixtures. The wrapping may be formed from one, two, or more layers of the water-soluble film material. The water-soluble film material of the first layer and of the additional layers, if present, may be the same or different. Particularly preferred are films which may be glued or sealed to form packaging such as tubes or cushions, for example, after they have been filled with an agent.

It is preferred that the water-soluble wrapping contains polyvinyl alcohol or a polyvinyl alcohol copolymer. Water-soluble wrappings which contain polyvinyl alcohol or a polyvinyl alcohol copolymer have good stability with sufficiently high solubility in water, in particular solubility in cold water.

Suitable water-soluble films for manufacturing the water-soluble wrapping are preferably based on a polyvinyl alcohol or a polyvinyl alcohol copolymer having a molecular weight in the range of 10,000 to 1,000,000 gmol⁻¹, preferably 20,000 to 500,000 gmol⁻¹, particularly preferably 30,000 to 100,000 gmol⁻¹, and in particular 40,000 to 80,000 gmol⁻¹.

Polyvinyl alcohol is typically produced by hydrolysis of polyvinyl acetate, since a direct synthetic route is not possible. The same applies for polyvinyl alcohol copolymers, which are correspondingly produced from polyvinyl acetate copolymers. It is preferred when at least one layer of the water-soluble wrapping contains a polyvinyl alcohol having a degree of hydrolysis of 70 to 100 mol-%, preferably 80 to 90 mol-%, particularly preferably 81 to 89 mol-%, and in particular 82 to 88 mol-%.

In addition, a polymer selected from the group comprising (meth)acrylic acid-containing (co)polymers, polyacrylamides, oxazoline polymers, polystyrene sulfonates, polyurethanes, polyesters, polyethers, polylactic acid, or mixtures of these polymers may be added to a polyvinyl alcohol-containing film material which is suitable for manufacturing the water-soluble wrapping. Polylactic acids are a preferred additional polymer.

In addition to vinyl alcohol, preferred polyvinyl alcohol copolymers include dicarboxylic acids as additional monomers. Suitable dicarboxylic acids are itaconic acid, malonic acid, succinic acid, and mixtures thereof, with itaconic acid being preferred.

Likewise preferred polyvinyl alcohol copolymers include, in addition to vinyl alcohol, an ethylenically unsaturated carboxylic acid, its salt, or its ester. In addition to vinyl alcohol, such polyvinyl alcohol copolymers particularly preferably contain acrylic acid, methacrylic acid, acrylic acid ester, methacrylic acid ester, or mixtures thereof.

It may be preferred that the film material contains further additives. The film material may contain, for example, softeners such as dipropylene glycol, ethylene glycol, diethylene glycol, propylene glycol, glycerin, sorbitol, mannitol, or mixtures thereof. Examples of further additives include release aids, fillers, crosslinking agents, surfactants, antioxidants, UV absorbers, antiblocking agents, non-stick agents, or mixtures thereof.

Suitable water-soluble films for use in the water-soluble wrappings of the water-soluble packaging according to the invention are films marketed by MonoSol LLC under the trade names M8630, C8400, or M8900, for example. Other suitable films include films with the trade names Solublon® PT, Solublon® GA, Solublon® KC, or Solublon® KL from Aicello Chemical Europe GmbH, or the VF-HP films from Kuraray.

The water-soluble wrapping contains, at least in part, a bittering agent having a bitterness value between 1,000 and 200,000.

The bittering agent having a bitterness value between 1,000 and 200,000 may be applied, for example, to the outer surface of the water-soluble wrapping, or may be contained in the water-soluble wrapping.

In one preferred embodiment of the invention, the outer surface of the water-soluble wrapping is at least partially coated with a bittering agent having a bitterness value between 1,000 and 200,000. In this regard, it is particularly preferred that the water-soluble wrapping is coated at least 50%, preferably at least 75%, and very particularly preferably at least 90%, with the bittering agent having a bitterness value between 1,000 and 200,000.

The bittering agent having a bitterness value between 1,000 and 200,000 may be applied by printing, spraying, or spreading, for example.

In principle, any form of printing may be used for printing the water-soluble wrapping, such as gravure printing, offset printing, screen printing, flexographic printing, airbrush, ink jet printing, or pad printing, or any given combinations of these printing technologies. The printing is preferably carried out using ink jet printing, since with this printing technology there is no mechanical contact with, and thus, no mechanical stress on, the water-soluble wrapping. The same applies for direct printing using piezo technology, since this process also takes place without contact.

In principle, the printing medium which is applied to the water-soluble wrapping may contain further ingredients, such as a coloring substance.

Alternatively, the bittering agent having a bitterness value between 1,000 and 200,000 may be spread onto the outer wrapping using a brush, roller, or the like.

In another alternative, the bittering agent having a bitterness value between 1,000 and 200,000 is sprayed on using an atomizer.

The bittering agent having a bitterness value between 1,000 and 200,000 may be applied in the form of surfaces, so that the water-soluble wrapping is covered, at least over a portion of its surface, with a bittering agent having a bitterness value between 1,000 and 200,000. Alternatively, the bittering agent having a bitterness value between 1,000 and 200,000 may be applied in the form of letters, numbers, symbols, decorative figures, or the like. The latter are particularly preferred when the bittering agent having a bitterness value between 1,000 and 200,000 is applied by printing, and the printing medium contains a coloring substance in addition to the bittering agent having a bitterness value between 1,000 and 200,000.

Alternatively, for application to the outer surface of the water-soluble wrapping, the bittering agent having a bitterness value between 1,000 and 200,000 may be incorporated into the film material of the water-soluble wrapping.

All chemical compounds which have a bitter taste are designated as bittering agents.

The bittering agent has a bitterness value between 1,000 and 200,000. The bitterness value is the reciprocal value of the dilution of a substance, a liquid, or an extract which just has a bitter taste.

The standardized method described in the European Pharmacopoeia (5th Edition, Main Volume, Stuttgart 2005, Volume 1, General Part, Monograph Groups, 2.8.15 Bitterness Value, p. 278) is used to determine the bitterness value.

An aqueous solution of quinine hydrochloride, whose bitterness value is defined to be 200,000, is used as a comparison. This means that 1 gram quinine hydrochloride makes 200 liters of water bitter. The interindividual taste differences in the organoleptic testing of bitterness are compensated for by a correction factor in this method.

Suitable bittering agents having a bitterness value between 1,000 and 200,000, which may be contained in the film material for manufacturing the water-soluble wrapping or may be applied to the outer surface of the water-soluble wrapping, are preferably natural bittering agents having a bitterness value between 1,000 and 200,000. The natural bittering agents having a bitterness value between 1,000 and 200,000 are particularly preferably selected from the group comprising glycosides, isoprenoids, alkaloids, amino acids, and mixtures thereof.

Glycosides are organic compounds having the general structure R—O—Z, in which an alcohol (R—OH) is connected to a sugar portion (Z) via a glycosidic bond.

Examples of suitable glycosides are flavonoids such as quercetin or naringin, iridoid glycosides such as aucubin, and in particular secoiridoid glycosides such as amarogentin, dihydrofoliamentin, gentiopicroside, gentiopicrin, swertiamarin, sweroside, gentioflavosid, centaurosid, metafolin, harpagoside, and centapicrine, sailicin, or condurangin.

Isoprenoids are compounds which are formally derived from isoprene. Examples are in particular terpenes and terpenoids.

Examples of suitable isoprenoids include sesquiterpene lactones such as absinthin, artabsin, cnicin, lactucin, lactucopicrin, or salonitenolid, monoterpene ketones (thujones) such as α-thujone or β-thujone, tetranortriterpenes (limonoids) such as deoxylimonene, deoxylimonenic acid, limonene, ichangin, isoobacunonic acid, obacunone, obacunonic acid, nomilin, or nomilinic acid, and terpenes such as marrubin, premarrubin, carnosol, carnosolic acid, or quassin.

Alkaloids refer to naturally occurring, chemically heterogeneous, usually alkaline, nitrogen-containing organic compounds of the secondary metabolism which act on the animal or human organism.

Examples of suitable alkaloids include quinine hydrochloride, quinine hydrogen sulfate, quinine dihydrochloride, quinine sulfate, columbin, and caffeine.

Examples of suitable amino acids include threonine, methionine, phenylalanine, tryptophan, arginine, histidine, valine, and asparagic acid.

Particularly preferred bittering agents having a bitterness value between 1,000 and 200,000 are quinine sulfate (bitterness value=10,000), naringin (bitterness value=10,000), saccharose octaacetate (bitterness value=100,000), quinine hydrochloride, and mixtures thereof.

Use of a mixture of bittering agents may be advantageous, since humans have a variable number of taste cells on the tongue. In addition to so-called supertasters and normal tasters, there are also so-called nontasters, who have little or no taste for the individual bittering agents. By using a mixture of at least two bittering agents having a bitterness value between 1,000 and 200,000, the risk that the intended deterrent of the bittering agent does not affect the taste may be reduced.

The quantity of bittering agent having a bitterness value between 1,000 and 200,000 depends in particular on the desired intensity of the bitter taste. If the bittering agent is contained in the water-soluble wrapping, the quantity of bittering agent is between 1 and 30 g per m² surface of the water-soluble wrapping. If the bittering agent is applied to the outer surface of the water-soluble wrapping, the quantity of bittering agent is between 1 and 30 g per m² coated surface of the water-soluble wrapping.

Within the scope of the present patent application, the term “inner surface of the water-soluble wrapping” means the surface which is in contact with the agent that is enclosed by the water-soluble wrapping. Correspondingly, the term “outer surface of the water-soluble wrapping” means the surface facing away from the agent that is enclosed by the water-soluble wrapping.

### Agents, in Particular Liquid, Gel, or Solid Detergent or Cleaning Agents, for Storing in the Water-Soluble Packaging

In addition to the water-soluble wrapping, the water-soluble packaging contains an agent. This agent may be a solid agent, for example, and may include a powder, a granulate, or a tablet. Alternatively, the agent may be a liquid agent and may include a gel or a liquid. The agent is particularly preferably a liquid or solid detergent or cleaning agent, with liquid detergents or cleaning agents being particularly preferred.

In one embodiment, the water-soluble packaging has a chamber for accommodating the agent. In this embodiment the agent may preferably include a powder, a granulate, a gel, or a liquid.

In another embodiment, the water-soluble packaging has two chambers. In this embodiment the first chamber preferably contains a liquid agent and the second chamber preferably contains a solid or a liquid agent. Alternatively, both chambers may contain a solid agent.

If the water-soluble packaging has three chambers, all of these chambers may contain a liquid or a solid agent in each case. However, it is also possible for one chamber to contain solid agent and for two chambers to contain a liquid agent. In addition, it is possible for two chambers to contain a solid agent and for one chamber to contain a liquid agent.

For water-soluble packaging having four or more chambers, there are correspondingly more possible combinations with regard to the number of chambers containing a solid or a liquid agent.

The agents contained in the various chambers of a water-soluble packaging may have the same composition. In a water-soluble packaging having at least two chambers, the agents preferably have compositions which differ with respect to at least one ingredient or at least with respect to the content of one ingredient.

The agent contains ingredients which do not destroy the structural integrity of the water-soluble wrapping. If the agent used is a liquid or solid detergent or cleaning agent, it may contain one or more substances from the group of surfactants, builders, bleaching agents, bleaching activators, bleach catalysts, enzymes, enzyme stabilizers, electrolytes, pH adjusters, fragrances, fragrance carriers, fluorescence agents, dyes, hydrotopes, foam inhibitors, silicone oils, anti-redeposition agents, graying inhibitors, shrinkage inhibitors, anti-crease agents, dye transfer inhibitors, antimicrobial active substances, nonaqueous solvents, germicides, fungicides, antioxidants, preservatives, corrosion inhibitors, anti-static agents, bittering agents, ironing aids, repellent and impregnation agents, opacifiers, skin care active substances, swelling and anti-slip agents, softening components, fillers, and UV absorbers.

The liquid detergents or cleaning agents may contain water, the water content being less than 14% by weight and more preferably less than 9% by weight, in each case based on the total liquid detergent or cleaning agent.

### Method for Manufacturing Water-Soluble Packaging

There are several options for manufacturing the water-soluble packaging according to the invention. In addition to the vertical form-fill-seal method, it is also possible in particular to use a horizontal form-fill-seal method.

The manufacturing of water-soluble packaging may include the following steps:
a) Forming at least one cavity in a first water-soluble film web,
b) Filling the at least one cavity with an agent, and
c) Closing the cavity with a second water-soluble film web.

In a first embodiment, the bittering agent having a bitterness value between 1,000 and 200,000 may be contained, at least in part, in the first water-soluble film (web). Alternatively, the bittering agent having a bitterness value between 1,000 and 200,000 may be contained, at least in part, in the second water-soluble film (web). In another alternative, it is also possible for the bittering agent having a bitterness value between 1,000 and 200,000 to be contained, at least in part, in both water-soluble film (webs). If the bittering agent having a bitterness value between 1,000 and 200,000 is contained in both water-soluble film (webs), the bittering agent having a bitterness value between 1,000 and 200,000 in the first film (web) may be the same as or different from the bittering agent having a bitterness value between 1,000 and 200,000 in the second film (web).

Accordingly, a further subject matter of the patent application relates to a method for manufacturing water-soluble packaging which contains an agent and a water-soluble wrapping which contains, at least in part, a bittering agent having a bitterness value between 1,000 and 200,000, including the following steps:
a) Forming at least one cavity in a first water-soluble film web,
b) Filling the at least one cavity with a product, and
c) Closing the cavity with a second water-soluble film web, wherein the bittering agent having a bitterness value between 1,000 and 200,000 is contained in the first and/or second water-soluble film web.

In one alternative embodiment of the method for manufacturing water-soluble packaging, step c) is followed by a further method step d) which includes the at least partial coating of the outer surface of the water-soluble wrapping with a medium which contains a bittering agent having a bitterness value between 1,000 and 200,000. Step d) may be repeated as often as desired, so that multiple coated areas, which are the same or different, may be provided on the outer surface of the water-soluble wrapping. The coating may be applied by printing, spraying, or spreading, for example.

Accordingly, a further subject matter of the invention relates to a method for manufacturing water-soluble packaging which contains an agent and a water-soluble wrapping which contains, at least in part, a bittering agent having a bitterness value between 1,000 and 200,000, including the following steps:
a) Forming at least one cavity in a first water-soluble film web,
b) Filling the at least one cavity with a product,
c) Closing the cavity with a second water-soluble film web and at least partially coating the outer surface of the water-soluble wrapping with a medium which contains the bittering agent having a bitterness value between 1,000 and 200,000.

In this embodiment, the film (webs) used may be free of bittering agent having a bitterness value between 1,000 and 200,000, or may also contain one or more bittering agents having a bitterness value between 1,000 and 200,000.

In another alternative embodiment of the method for manufacturing water-soluble packaging, the coating of the first water-soluble film with the bittering agent having a bitterness value between 1,000 and 200,000 takes place prior to forming the cavity. In yet another alternative embodiment of the method for manufacturing water-soluble packaging, the coating of the second water-soluble film with the bittering agent having a bitterness value between 1,000 and 200,000 takes place prior to closing the cavity which is filled with the agent.

A further subject matter of the present invention therefore relates to a method for manufacturing water-soluble packaging which contains an agent and a water-soluble wrapping which contains, at least in part, a bittering agent having a bitterness value between 1,000 and 200,000, including the following steps:
a) Providing a first water-soluble film web,
b) Coating the first water-soluble film web with a medium which contains the bittering agent having a bitterness value between 1,000 and 200,000,
c) Forming at least one cavity in the first water-soluble film web,
d) Filling the at least one cavity with a product, and
e) Closing the cavity with a second water-soluble film web.

Yet a further subject matter of the invention relates to a method for manufacturing water-soluble packaging which contains an agent and a water-soluble wrapping which contains, at least in part, a bittering agent having a bitterness value between 1,000 and 200,000, including the following steps:
a) Forming at least one cavity in the first water-soluble film web,
b) Filling the at least one cavity with a product,
c) Providing a second water-soluble film web,
d) Coating the second water-soluble film web with a medium which contains the bittering agent having a bitterness value between 1,000 and 200,000, and
e) Closing the cavity with the second water-soluble film web.

The coating of the water-soluble film web during the manufacture of the water-soluble packaging takes place in such a way that the bittering agent having a bitterness value between 1,000 and 200,000 is present on the outer surface of the water-soluble wrapping.

One advantage of coating during or after the manufacture of the water-soluble packaging is that the coating may take place in an individualized manner, i.e., according to the requirements/circumstances, for example with regard to the form and content of the particular water-soluble packaging being manufactured at the time.

The coating operation may optionally be followed by a drying process in which solvent contained in the medium which contains the bittering agent having a bitterness value between 1,000 and 200,000 is evaporated/removed by blowing temperature-controlled gas on or over, or by irradiation with infrared light.

For manufacturing a water-soluble wrapping which contains, at least in part, a bittering agent having a bitterness value between 1,000 and 200,000, the bittering agent having a bitterness value between 1,000 and 200,000 is added to the film material.

This may take place, for example, by (a) combining a water-soluble polymer which preferably contains polyvinyl alcohol or a polyvinyl alcohol copolymer, alone or in combination, with at least one additional water-soluble polymer, a solvent, the bittering agent having a bitterness value between 1,000 and 200,000, and optionally further additives to form a matrix, (b) forming a film from the matrix, and (c) drying the film to form a water-soluble film which contains, at least in part, a bittering agent having a bitterness value between 1,000 and 200,000.

The film may be formed by pouring and reverse roller coating, for example.

Alternatively, a film containing, at least in part, a bittering agent having a bitterness value between 1,000 and 200,000 may be obtained by (a) combining a water-soluble polymer which preferably contains polyvinyl alcohol or a polyvinyl alcohol copolymer, alone or in combination, with at least one additional water-soluble polymer, a solvent, the bittering agent having a bitterness value between 1,000 and 200,000, and optionally further additives to form a matrix, and (b) obtaining a water-soluble film which contains, at least in part, a bittering agent having a bitterness value between 1,000 and 200,000 by extrusion of the matrix.

The invention is explained in greater detail below with reference to two exemplary embodiments.

For manufacturing a water-soluble packaging which has a chamber that is filled with a liquid detergent or cleaning agent, first a liquid detergent or cleaning agent was produced using known, conventional methods and processes. Table 1 shows the composition of a liquid detergent or cleaning agent E1.

TABLE 1
Liquid detergent or cleaning agent E1 [all quantities are expressed
in % by weight active substance, based on the composition]

| Ingredient | E1 |
|---|---|
| C₁₀-C₁₃ alkylbenzenesulfonic acid | 21 |
| C₁₃-C₁₅ oxo alcohol having 8 EO | 22.5 |
| C₁₂₋₁₈ fatty acid | 17.5 |
| Glycerin | 13 |
| 1,2-Propanediol | 13.5 |
| Ethanol | 3.26 |
| Phosphonate | 0.3 |
| Monoethanolamine | 6.4 |
| Dyes, enzymes (cellulase, amylase, protease), | 0.8 |
| optical brightener, fragrance | |
| Water | 1.74 |

### Exemplary Embodiment 1

For manufacturing water-soluble packaging containing the liquid detergent or cleaning agent E1, a film of type M 8630 (from Monosol) having a thickness of 76 μm was pulled by vacuum into a cavity to form a protrusion. The protrusion was subsequently filled with 30 mL of the liquid detergent or cleaning agent E1. After covering the protrusions, filled with the agent, with a second layer of a film containing polyvinyl alcohol, polylactic acid, 1,2-propanediol, and glycerin and having a thickness of 76 μm, the first and second layers were sealed together. The sealing temperature was 150° C., and the sealing duration was 1.1 seconds.

The entire outer surface of the water-soluble packaging was then uniformly sprayed on both sides with an aqueous medium containing saccharose octaacetate, using an atomizer. The quantity of saccharose octaacetate per water-soluble package was 2000 ppm. The liquid was absorbed by the water-soluble wrapping within 5 seconds.

### Exemplary Embodiment 2

For manufacturing water-soluble packaging V2 containing the liquid detergent or cleaning agent E1, a first layer of a film containing polyvinyl alcohol, polylactic acid, saccharose octaacetate, 1,2-propanediol, and glycerin, having a thickness of 76 μm, was pulled by vacuum into a cavity to form a protrusion. The protrusion was subsequently filled with 30 mL of the liquid detergent or cleaning agent E1. After covering the protrusions, filled with the agent, with a second layer of a film containing polyvinyl alcohol, polylactic acid, saccharose octaacetate, 1,2-propanediol, and glycerin and having a thickness of 76 μm, the first and second layers were sealed together. The sealing temperature was 150° C., and the sealing duration was 1.1 seconds. The first and second film webs each contained 2000 ppm saccharose octaacetate.

In both cases, a quickly discernible, unpleasant bitter taste of the water-soluble wrapping was confirmed by a panel of 10 individuals.

After 4, 8, and 12 weeks storage time of the water-soluble packaging V1 and V2 containing the detergent or cleaning agent E1 under various climatic conditions, no solubilization or dissolution of the water-soluble wrapping was observable. In addition, no pores or holes were identified which would likewise result in escape or leakage of product.

Water-soluble packagings V1 and V2 containing the detergent or cleaning agent E1 dissolved without residue in wash operations at temperatures in a range from 20 to 95° C.

In addition, no persistent and/or objectionable transfer of the bittering agents to the skin was identifiable upon contact of the water-soluble packaging with skin, in particular upon contact with dry or slightly damp hands.

The determination of whether a persistent and/or objectionable transfer of the bittering agent was present was made with the assistance of 10 test subjects who held a water-soluble package tightly in the hand for 5 seconds and subsequently brought the hand into contact with the tongue for 5 seconds. For both water-soluble packaging V1 and V2, all of the test subjects noticed no bitter taste, or noticed a slightly unpleasant bitter taste which only lasted for 1 minute maximum.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. Method for manufacturing water-soluble packaging which comprises an agent and a water-soluble wrapping which further comprises a bittering agent having a bitterness value between 1,000 and 200,000, including the following steps:
a) forming at least one cavity in a first water-soluble film web,
b) filling the at least one cavity with a product, and
c) closing the cavity with a second water-soluble film web,
d) wherein the bittering agent having a bitterness value between 1,000 and 200,000 is contained in the first and/or second water-soluble film web.

2. Method for manufacturing water-soluble packaging which comprises an agent and a water-soluble wrapping which further comprises a bittering agent having a bitterness value between 1,000 and 200,000, including the following steps:
a) forming at least one cavity in a first water-soluble film web,
b) filling the at least one cavity with a product, and
c) closing the cavity with a second water-soluble film web, and
d) at least partially coating the outer surface of the water-soluble wrapping with a medium which comprises the bittering agent having a bitterness value between 1,000 and 200,000.

3. Method for manufacturing water-soluble packaging which comprises an agent and a water-soluble wrapping which further comprises a bittering agent having a bitterness value between 1,000 and 200,000, including the following steps:
a) providing a first water-soluble film web,
b) coating the first water-soluble film web with a medium which comprises the bittering agent having a bitterness value between 1,000 and 200,000,
c) forming at least one cavity in the first water-soluble film web,
d) filling the at least one cavity with a product, and
e) closing the cavity with a second water-soluble film web.

4. Method for manufacturing water-soluble packaging which comprises an agent and a water-soluble wrapping which further comprises a bittering agent having a bitterness value between 1,000 and 200,000, including the following steps:
a) forming at least one cavity in the first water-soluble film web,
b) filling the at least one cavity with a product,
c) providing a second water-soluble film web,
d) coating the second water-soluble film web with a medium comprising the bittering agent having a bitterness value between 1,000 and 200,000, and
e) closing the cavity with the second water-soluble film web.

5. Method for manufacturing water-soluble packaging according to claim 1, wherein the coating of the water-soluble film web takes place in such a manner that the bittering agent having a bitterness value between 1,000 and 200,000 is present on the outer surface of the water-soluble wrapping.
